(19) United States
(12) Patent Application Publication
(10) Pub. No.: US 2025/0077826 A1
(43) Pub. Date: Mar. 6, 2025

(54) SMART KEY DEVICE

(71) Applicants: INVENTEC (PUDONG) TECHNOLOGY CORPORATION, Shanghai (CN); INVENTEC CORPORATION, Taipei City (TW)

(72) Inventor: Ming Liang YU, Shanghai City (CN)

(73) Assignees: INVENTEC (PUDONG) TECHNOLOGY CORPORATION, Shanghai (CN); INVENTEC CORPORATION, Taipei City (TW)

(21) Appl. No.: 18/367,903

(22) Filed: Sep. 13, 2023

(30) Foreign Application Priority Data
Aug. 30, 2023 (CN) 202311114740.3

(51) Int. Cl. G06K 19/07; H02J 7/00

(52) U.S. Cl. CPC G06K 19/0702; H02J 7/0048

(57) ABSTRACT

A smart key device includes a battery, a power detection module, a power indication module, and a microcontroller, wherein the battery is electrically connected to the power detection module and the microcontroller, and the microcontroller is electrically connected to the power detection module and the power indication module. The power detection module is configured to be controlled by the first control signal to detect remaining power. The power indication module is configured to be controlled by a second control signal to indicate the remaining power. The microcontroller is configured to generate the first control signal and the second control signal, wherein the second control signal includes the remaining power.

### CROSS-REFERENCE TO RELATED APPLICATIONS

This non-provisional application claims priority under 35 U.S.C. § 119 (a) on Patent Application No(s). 202311114740.3 filed in China on Aug. 30, 2023, the entire contents of which are hereby incorporated by reference.

### BACKGROUND

### 1. Technical Field

This disclosure relates to a smart key device.

### 2. Related Art

Traditional smart keys have the functions of remote locking, remote unlocking and sound prompts after triggering the button.

With the development of smart keys, their functions become more diverse than traditional keys. When the smart key is out of power, it cannot be used, so the batteries of smart keys usually need to be replaced or recharged. Therefore, failure to access the remaining power of the smart key when the smart key is going to be out of power may result in the smart key being unable to be used because the battery cannot be replaced or charged in time.

### SUMMARY

Accordingly, this disclosure provides a smart key device.

According to one or more embodiment of this disclosure, a smart key device includes a battery, a power detection module, a power indication module and a microcontroller, wherein the battery is electrically connected to the power detection module and the microcontroller, and the microcontroller is electrically connected to the power detection module and the power indication module. The power detection module is configured to be controlled by a first control signal to detect remaining power of the battery. The power indication module is configured to be controlled by a second control signal to indicate the remaining power. The microcontroller is configured to generate the first control signal and the second control signal, wherein the second control signal includes the remaining power.

In view of the above description, the smart key device of the present disclosure can detect remaining power of battery through the power detection module, and indicate the remaining power detected by the power detection module through the power indication module.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of a smart key device according to one embodiment of the present disclosure;

FIG. 2 is a block diagram of a smart key device according to another embodiment of the present disclosure;

FIG. 3 schematically illustrate a circuit of a power detection module of the smart key device according to another embodiment of the present disclosure; and

FIG. 4 schematically illustrate a circuit of a power detection module of the smart key device according to still another embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

The smart key device described in one or more embodiments of the present disclosure may be used to unlock and/or start or perform other controlling on a paired object. The paired object is in particular a vehicle, which can be paired in a mechanical way or/and based on wireless communication technology (such as Bluetooth).

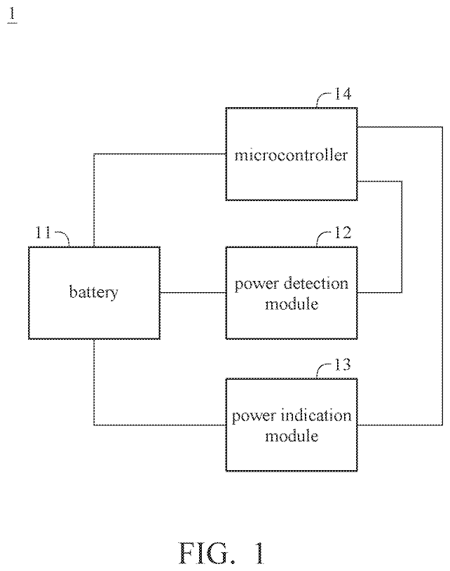

Please refer to FIG. 1 which is a block diagram of a smart key device according to one embodiment of the present disclosure. As shown in FIG. 1, the smart key device 1 includes a battery 11, a power detection module 12, a power indication module 13 and a microcontroller 14. The microcontroller 14 is electrically connected to the battery 11, the power detection module 12 and the power indication module 13. The power detection module 12 and the power indication module 13 are electrically connected to the battery 11.

The battery 11 is configured to receive electric energy, store electric energy and provide electric energy to the electric power detection module 12, the power indication module 13, the microcontroller 14 and other components of the smart key device 1. The power detection module 12 is configured to be controlled by a control signal (hereinafter referred to as a first control signal) of the microcontroller 14 to detect remaining power of the battery 11. Specifically, when the power detection module 12 receives the first control signal, it starts to detect the remaining power of the battery 11.

The power indication module 13 is configured to be controlled by the control signal (hereinafter referred to as a second control signal) of the microcontroller 14 to indicate the remaining power. For example, the power indication module 13 can include at least one of a display, a prompt light, and a speaker.

The microcontroller 14 is configured to generate a first control signal and a second control signal, wherein the second control signal includes the remaining power. Specifically, the microcontroller 14 detects the remaining power of the battery 11 through the power detection module 12, and then indicates the remaining power of the battery 11 through the power indication module 13.

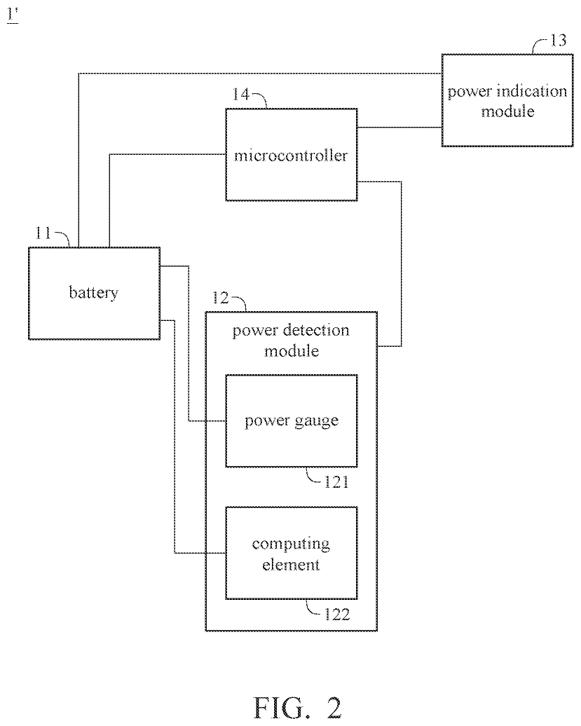

Please refer to FIG. 2 which is a block diagram of a smart key device according to another embodiment of the present disclosure. As shown in FIG. 2, the smart key device 1′ includes a battery 11, a power detection module 12, a power indication module 13 and a microcontroller 14, and the power detection module 12 includes a power gauge 121 and a computing element 122, wherein the functions and connection relationships of the battery 11, the power indication module 13 and the microcontroller 14 are the same as those of the battery 11, the battery indicator module 13, and the microcontroller 14 included in the smart key device 1 of FIG. 1, and their descriptions will not be repeated here.

The power gauge 121 is electrically connected to the battery 11 and the microcontroller 14, and is configured to calculate the total charge charged to the battery 11 and the output charge released by the battery 11 to obtain the remaining power. Specifically, the difference between the total charge and the output charge of the battery 11 is divided by the total charge of the battery 11 to determine the remaining power. In addition, the power gauge 121 can be connected to the microcontroller 14 through an inter-integrated circuit (I²C).

The computing element 122 is, for example, another microcontroller or other electronic component with computing functions. The computing element 122 is electrically connected to the battery 11 and the microcontroller 14, and pre-stores a preset minimum voltage value and a preset maximum voltage value of the battery 11. The computing element 122 is configured to obtain a difference between a voltage of the battery 11 and the preset minimum voltage value of the battery 11, and calculate a ratio of the difference to the preset maximum voltage value of the battery 11 to obtain the remaining power. Specifically, the value obtained by subtracting the preset minimum voltage value of the battery 11 from the voltage of the battery 11 is multiplied by one hundred and then divided by the preset maximum voltage value of the battery 11 as the remaining power. Furthermore, when the battery 11 discharges, the voltage of the battery 11 will gradually decrease with the loss of battery power. Through the discharge curve of the normal use of the battery 11, the change of voltage over time is divided into four equal parts. Taking the charging limit voltage of 4.2 volts (V) as an example, the relationship between the voltage and capacity of the battery 11 can be as follows: 4.2V corresponds to 100% capacity. 3.85V corresponds to 75% capacity, 3.75V corresponds to 50% capacity, 3.6V corresponds to 25% capacity, and 3.4V corresponds to 5% capacity. In addition, the computing element 122 can have the advantages of simple design and lower cost compared to the power gauge 121.

In this embodiment, the power gauge 121 and the computing element 122 can be selectively disposed, and the remaining power can be provided by the power gauge 121 or the computing element 122. The power gauge 121 and the computing element 122 can also be disposed at the same time. One of the power gauge 121 and the computing element 122 is selected in a predetermined order as a component for calculating the remaining power, and when the microcontroller 14 determines that the value of the remaining power is abnormal, another component is selected to calculate the remaining power. In addition, the power gauge 121 is free from voltage measurement distortions compared to the computing element 122 to calculate the remaining power, the distortions may be such as voltage distortion caused by the internal resistance of the battery 11, voltage distortion caused by transient effects, and large estimation errors in battery power caused by small voltage changes in the flat area of the discharge curve. The power gauge 121 can accurately measure the battery power even when there is current flowing through the battery 11, so the power gauge 121 has higher accuracy than the computing element 122.

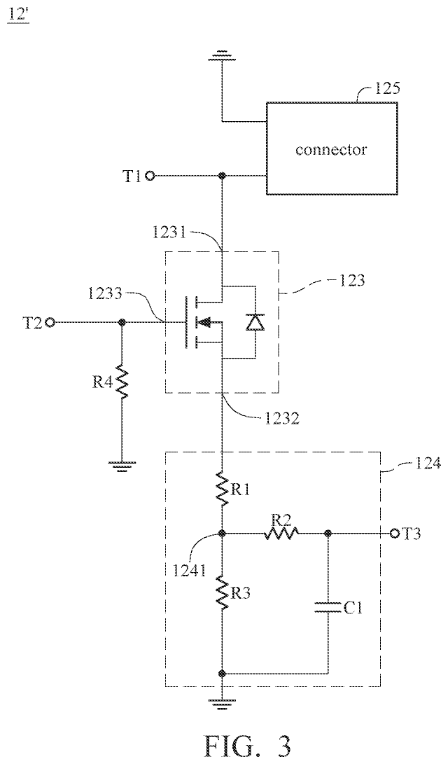

In other embodiments, the power detection module of the smart key device may be implemented in other ways. Please refer to FIG. 1 and FIG. 3, FIG. 3 schematically illustrate a circuit of a power detection module of the smart key device according to another embodiment of the present disclosure. The power detection module 12′ shown in FIG. 3 can be used as the power detection module 12 in FIG. 1. As shown in FIG. 3, the power detection module 12′ may include a switch element 123, a voltage divider circuit 124 and a connector 125. In this embodiment, the microcontroller 14 pre-stores the preset minimum voltage value and the preset maximum voltage value of the battery 11, and can obtain the voltage of the battery through the power detection module 12′, and execute the method of obtaining remaining power executed by the computing element 122 of FIG. 2.

The switch element 123 has a first terminal 1231, a second terminal 1232 and a control terminal 1233. The first terminal 1231 is electrically connected to the battery 11 and the connector 125, and the control terminal 1233 is electrically connected to the microcontroller 14. Specifically, the first terminal 1231 is electrically connected to the battery 11 through a terminal T1, and the control terminal 1233 is electrically connected to the microcontroller 14 through a terminal T2. Furthermore, the control terminal 1233 of the switch element 123 is connected to the microcontroller 14 through a general-purpose input/output (GPIO). In addition, when the microcontroller 14 enters the sleep mode, the switch element 123 is controlled to be turned off by the microcontroller 14. Thereby, the battery 11 is disconnected from the voltage divider circuit 124 and the operating current is reduced.

The voltage divider circuit 124 is electrically connected to the second terminal 1232 of the switch element 123 and the microcontroller 14. The terminal 1241 of the voltage divider circuit 124 is connected to resistors R1, R2 and R3 respectively. The other end of the resistor R1 is connected to the second terminal 1232 of the switch element 123, the other end of the resistor R2 is connected to a capacitor C1, and the other end of the resistor R3 and the capacitor C1 are grounded. Specifically, the voltage divider circuit 124 is electrically connected to the microcontroller 14 through a terminal T3.

The connector 125 is used as an interface of the battery 11. Specifically, the connector 125 provides an interface for the battery 11 to be connected to other components, such as the battery indication module 13.

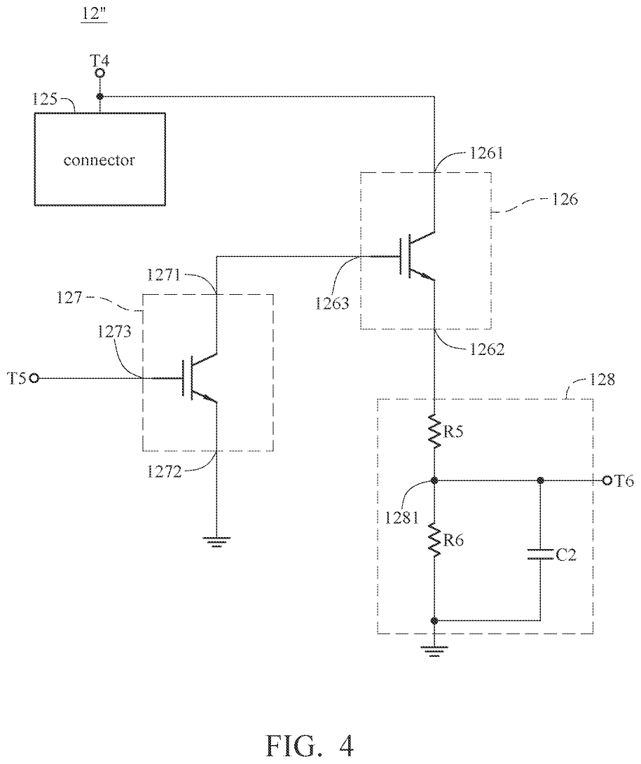

In other embodiments, the power detection module of the smart key device may be implemented in other ways. Please refer to FIG. 1 and FIG. 4, FIG. 4 schematically illustrate a circuit of a power detection module of the smart key device according to still another embodiment of the present disclosure. The power detection module 12″ shown in FIG. 4 can be used as the power detection module 12 of FIG. 1. As shown in FIG. 4, the power detection module 12″ can include a connector 125, a first switch element 126, a second switch element 127 and a voltage divider circuit 128. The function and connection relationship of the connector 125 are the same as those of the connector 125 included in the power detection module 12′ in FIG. 3, and its descriptions will not be repeated here. In this embodiment, the microcontroller 14 pre-stores the preset minimum voltage value and the preset maximum voltage value of the battery 11, and can obtain the voltage of the battery through the power detection module 12″, and execute the method of obtaining remaining power executed by the computing element 122 of FIG. 2.

The first switch element 126 has a first terminal 1261, a second terminal 1262 and a control terminal 1263, wherein the first terminal 1261 is electrically connected to the battery 11. Specifically, the first terminal 1261 is electrically connected to the battery 11 through a terminal T4. In addition, when the microcontroller 14 enters the sleep mode, the first switch element 126 is controlled to be turned off by the microcontroller 14. Thereby, the battery 11 is disconnected from the voltage divider circuit 128, and the operating current is reduced.

The second switch element 127 has a first terminal 1271, a second terminal 1272 and a control terminal 1273. The first terminal 1271 is electrically connected to the first terminal 1261 and the control terminal 1263 of the first switch element 126, the second terminal 1272 is grounded, and the control terminal 1273 is electrically connected to the microcontroller 14. Specifically, the control terminal 1273 is electrically connected to the microcontroller 14 through a terminal T5.

The voltage divider circuit 128 is electrically connected to the second terminal 1262 of the first switch element 126 and the microcontroller 14. A terminal 1281 of the voltage divider circuit 128 is connected to resistors R5, R6 and a capacitor C2 respectively. The other end of the resistor R5 is connected to the second terminal 1262 of the first switch element 126, and the other end of the resistor R6 and the capacitor C2 are grounded. Specifically, the voltage divider circuit 128 is electrically connected to the microcontroller 14 through a terminal T6.

In this embodiment, the second terminal 1272 of the second switch element 127 and the voltage divider circuit 128 are respectively connected to the microcontroller 14 through a general-purpose input and output (GPIO).

In view of the above description, the smart key device of the present disclosure can detect remaining power of battery through the power detection module, and indicate the remaining power detected by the power detection module through the power indication module.

What is claimed is:

1. A smart key device comprising:
a battery;
a power detection module electrically connected to the battery, and controlled by a first control signal to detect remaining power of the battery;
a power indication module controlled by a second control signal to indicate the remaining power; and
a microcontroller electrically connected to the battery, the power detection module and the power indication module, and configured to generate the first control signal and the second control signal, wherein the second control signal comprises the remaining power.

2. The smart key device of claim 1, wherein the power detection module comprises a power gauge, the power gauge is configured to calculate an input charge charged to the battery and an output charge released by the battery to obtain the remaining power.

3. The smart key device of claim 2, wherein the power gauge is connected to the microcontroller through an inter-integrated circuit.

4. The smart key device of claim 1, wherein the power detection module comprises a computing element, and is configured to obtain a difference between a voltage of the battery and a preset minimum voltage value of the battery, and calculate a ratio of the difference to a preset maximum voltage value of the battery to obtain the remaining power.

5. The smart key device of claim 1, wherein the power detection module further comprises:
a switch element having a first terminal, a second terminal and a control terminal, wherein the first terminal is electrically connected to the battery, and the control terminal is electrically connected to the microcontroller; and
a voltage divider circuit electrically connected to the second terminal of the switch element and the microcontroller,
wherein the microcontroller is further configured to obtain a difference between a voltage of the battery and a preset minimum voltage value of the battery, and calculate a ratio of the difference to a preset maximum voltage value of the battery to obtain the remaining power.

6. The smart key device of claim 5, wherein the control terminal of the switch element is connected to the microcontroller through a general-purpose input/output.

7. The smart key device of claim 5, wherein when the microcontroller enters a sleep mode, the switch element is controlled to be turned off.

8. The smart key device of claim 1, wherein the power detection module further comprises:
a first switch element having a first terminal, a second terminal and a control terminal, wherein the first terminal is electrically connected to the battery;
a second switch element having a first terminal, a second terminal and a control terminal, wherein the first terminal is electrically connected to the first terminal of and the control terminal of the first switch element, the second terminal is grounded, and the control terminal is electrically connected to the microcontroller; and
a voltage divider circuit electrically connected to the second terminal of the first switch element and the microcontroller,
wherein the microcontroller is further configured to obtain a difference between a voltage of the battery and a preset minimum voltage value of the battery, and calculate a ratio of the difference to a preset maximum voltage value of the battery to obtain the remaining power.

9. The smart key device of claim 8, wherein the control terminal of the second switch element and the voltage divider circuit are connected to the microcontroller through a general-purpose input/output, respectively.

10. The smart key device of claim 1, wherein the power indication module comprises at least one of a display, a prompt light, and a speaker.
